(19) United States
(12) Patent Application Publication
(10) Pub. No.: US 2026/0301688 A1
(43) Pub. Date: Oct. 1, 2026

(54) SCAN CIRCUIT, DISPLAY DEVICE INCLUDING THE SAME, AND ELECTRONIC DEVICE INCLUDING THE DISPLAY DEVICE

(71) Applicant: Samsung Display Co., LTD., Yongin-si (KR)

(72) Inventors: Yongchan Kim, Yongin-si (KR); NACKHYEON KEUM, Yongin-si (KR); KYUNG-HOON KIM, Yongin-si (KR); Jooyoung Chun, Yongin-si (KR)

(21) Appl. No.: 19/566,428

(22) Filed: Mar. 13, 2026

(30) Foreign Application Priority Data
Mar. 26, 2025 (KR) 10-2025-0038775

(51) Int. Cl. G09G 3/3266; G09G 3/32

(52) U.S. Cl. CPC G09G 3/3266; G09G 3/32; G09G 2310/0267; G09G 2330/021

(57) ABSTRACT

A scan driver includes a stage configured to generate a carry signal and provide the carry signal to a next stage, a first circuit configured to receive an enable signal and generate, based on the enable signal, a first signal and a second signal which are for selecting an input signal, a second circuit configured to receive the first signal and the second signal and provide one of a first input signal and a second input signal to the stage based on the first signal and the second signal. The stage includes a driver configured to output a gate signal based on one of the first input signal and the second input signal.

### CROSS-REFERENCE TO RELATED APPLICATION

This application claims priority to Korean Patent Application No. 10-2025-0038775, filed on, Mar. 26 2025, and all the benefits accruing therefrom under 35 U.S.C. §119, the content of which in its entirety is herein incorporated by reference.

### BACKGROUND

### 1. Field

The disclosure relates to a scan circuit, a display device including the same, and an electronic device including the same.

### 2. Description of the Related Art

Generally, a display device includes a display panel, a gate driver, a data driver, and a timing controller. The display panel includes a plurality of gate lines, a plurality of data lines, and a plurality of pixels electrically connected to the plurality of gate lines and the plurality of data lines. The gate driver provides gate signals to the gate lines, the data driver supplies data voltages to the data lines, and the timing controller controls the gate driver and the data driver.

There has been a demand to reduce power consumption of display devices. In particular, there has been a demand to reduce power consumption of display devices in mobile devices such as smart phones and tablet computers. In order to reduce the power consumption of the display devices, a low-frequency driving technology for driving or refreshing a display panel at a relatively low frequency that is lower than a normal driving frequency of the display panel has been developed.

### SUMMARY

According to a conventional display device to which the low-frequency driving technology is applied, when a still image is not displayed in an entirety of the region of a display panel, that is, when a still image is displayed only in a partial region of the display panel, the entirety of the region of the display panel is driven at a normal driving frequency. Accordingly, in this case, low-frequency driving may not be performed, and power consumption may not be reduced.

In order to reduce power consumption even when a still image is displayed only in a partial region of the display panel, a multi-frequency driving (“MFD”) technology for driving partial regions of the display panel at mutually different driving frequencies has been developed. According to a display device to which the multi-frequency driving technology is applied, a first display area in which a moving image is displayed may be driven at a normal driving frequency, and a second display area in which a still image is displayed may be driven at a relatively low frequency that is lower than the normal driving frequency. Accordingly, power consumption may be reduced even when the still image is displayed only in the second display area.

Some embodiments of the disclosure are directed to providing a scan circuit, a display device including the same, and an electronic device including the same. The problem to be solved by the disclosure is not limited to the above-mentioned problem, and other problems and advantages of the disclosure not mentioned may be understood by the following description and more clearly understood by the embodiments of the disclosure. In addition, the problems and advantages to be solved by the disclosure may be realized by means and any combinations thereof disclosed in the claims.

In an embodiment of the disclosure, there is provided a scan driver including a stage configured to generate a carry signal and provide the carry signal to a next stage, a first circuit configured to receive an enable signal and generate, based on the enable signal, a first signal and a second signal which are for selecting an input signal, a second circuit configured to receive the first signal and the second signal and provide one of a first input signal and a second input signal to the stage based on the first signal and the second signal, where the stage includes a driver configured to output a gate signal based on one of the first input signal and the second input signal.

### BRIEF DESCRIPTION OF THE DRAWINGS

The above and other features and advantages of illustrative embodiments of the disclosure will be more apparent from the following description taken in conjunction with the accompanying drawings in which:

FIG. 1 is a plan view schematically illustrating an embodiment of a display device according to the disclosure;

FIG. 2 is a block diagram illustrating an embodiment in which a display panel of a display device is driven according to the disclosure;

FIG. 3 is a conceptual diagram schematically illustrating an embodiment of a display device according to the disclosure;

FIG. 4 is a circuit diagram illustrating an embodiment of a pixel circuit according to the disclosure;

FIG. 5 is a block diagram illustrating an embodiment of an embodiment of a scan driver according to the disclosure;

FIG. 6 is a circuit diagram illustrating an embodiment of an embodiment of a first circuit of the scan driver shown in FIG. 5;

FIG. 7 is a circuit diagram illustrating an embodiment of an embodiment of a second circuit of the scan driver shown in FIG. 5;

FIG. 8 is a circuit diagram illustrating another embodiment of the second circuit of the scan driver shown in FIG. 5;

FIG. 9 is a circuit diagram illustrating another embodiment of the second circuit of the scan driver shown in FIG. 5;

FIG. 10 is a circuit diagram illustrating an embodiment of the scan driver shown in FIG. 5;

FIG. 11 is a timing diagram illustrating an embodiment of an operation of the scan driver shown in FIG. 5;

FIG. 12 is a block diagram of an embodiment of an electronic device according to the disclosure; and

FIG. 13 is a set of schematic views of embodiments of electronic devices according to the disclosure.

### DETAILED DESCRIPTION

While the disclosure is susceptible to various modifications and alternative forms, illustrative embodiments thereof are shown in the drawings and will herein be described in detail. Advantages and features of the disclosure and methods for accomplishing the same will be more clearly understood from embodiments described below with reference to the drawings. However, the disclosure is not limited to the embodiments disclosed below but may be implemented in various forms.

In the following embodiments, the terms “first,” “second,” and the like have been used to distinguish one component from another, rather than limitative in all features.

In the following embodiments, singular forms are intended to include plural forms as well, unless the context clearly indicates otherwise.

It will be further understood that the terms “including” and/or “having” used herein specify the presence of stated features or components, but do not preclude the presence or addition of one or more other features or components.

In the following embodiments, when a unit, region, or component is referred to as being “formed on” another unit, region, or component, it may be directly or indirectly formed on the other unit, region, or component. That is, for example, intervening units, regions, or components may be present.

In the following embodiments, terms such as “connecting” or “coupling” two members do not necessarily mean a direct and/or fixed connection or coupling of the two members, unless the context clearly indicates otherwise, and do not preclude another members from being interposed between the two members.

Sizes of components in the drawings may be exaggerated or reduced for convenience of description. For example, the size and/or thickness of each component shown in the drawings are arbitrarily represented for convenience of description, and thus, the disclosure is not necessarily limited thereto.

In the following embodiments, the term “on” used in connection with an element state may refer to an activated state of an element, and the term “off” used in connection with the element state may refer to a deactivated state of the element. The term “on” used in connection with a signal received by the element may refer to a signal that activates the element, and the term “off” used in connection with the signal received by the element may refer to a signal that deactivates the element. The element may be activated by a relatively high voltage or a relatively low voltage. For example, a P-type transistor is activated by a relatively low voltage. An N-type transistor is activated by a relatively high voltage. Thus, it should be understood that an “on” voltage of the P-type transistor has an opposite (low to high) voltage level with respect to an “on” voltage of the N-type transistor.

In the following embodiment, when an element is referred to as being “connected to another element, it may be directly connected to another element or intervening elements may be present.

Hereinafter, the embodiments of the disclosure will be described below in detail with reference to the accompanying drawings, and when the embodiments of the disclosure are described with reference to the drawings, the same or corresponding components are given the same reference numerals, and repetitive descriptions thereof will be omitted.

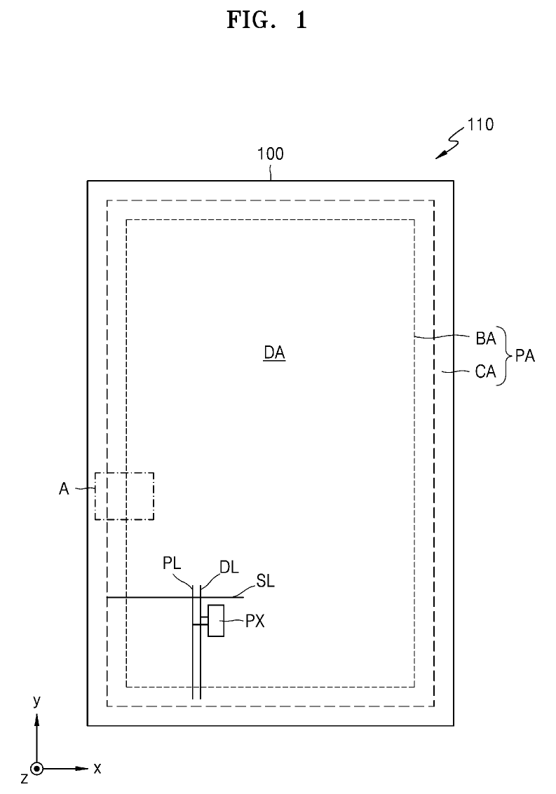

FIG. 1 is a plan view schematically illustrating an embodiment of a display device according to the disclosure.

As illustrated in FIG. 1, a display device in an embodiment of the disclosure may include a display panel 110. Any device that includes the display panel 110 may be applicable as a display device. In an embodiment, the display device may be any of various types of devices such as a smartphone, a tablet, a laptop computer, a television, or an advertising panel, for example. The display device in an embodiment of the disclosure may include thin-film transistors, capacitors, or the like, which may be implemented by conductive layers and insulating layers.

The display panel 110 may include a liquid crystal display panel, an organic light-emitting display panel, or an inorganic light-emitting display panel, and is not particularly limited in type. The display panel 110 may be of a rigid type, or of a flexible type capable of rolling or folding. A display module, which includes the display panel 110, may further include a supporter that supports the display panel 110, a bracket, a heat dissipation member, or the like.

The display panel 110 includes a display area DA and a peripheral area PA disposed outside the display area DA. In FIG. 1, the display area DA is illustrated as having a quadrangular shape, e.g., rectangular shape, but the disclosure is not limited thereto. The display area DA may have various shapes, such as a circular shape, an elliptical shape, a polygonal shape, or a shape of a predetermined geometric figure.

The display area DA is a portion in which an image is displayed, and a plurality of pixels PX may be disposed therein. Each of the pixels PX may include a display element such as an organic light-emitting element. Each of the pixels PX may emit, e.g., red, green, or blue light. The pixel PX may be connected to a pixel circuit including a thin-film transistor (“TFT”), a storage capacitor, or the like. The pixel circuit may be connected to a scan line SL, through which a scan signal is transmitted, a data line DL, which intersects the scan line SL and through which a data signal is transmitted, a drive voltage line PL, through which a drive voltage is supplied, or the like. The data line DL and the drive voltage line PL may extend in a y-axis direction (hereinafter referred to as a first direction), and the scan line SL may extend in an x-axis direction (hereinafter referred to as a second direction).

The pixel PX may emit light having a luminance corresponding to an electrical signal from the pixel circuit electrically connected thereto. The display area DA may display a predetermined image through light emitted from the pixel PX. It is noted that the term “pixel PX” may be defined as a light-emitting area that emits light of one of red, green, or blue colors.

The peripheral area PA may be an area in which no pixels PX are disposed and no image is displayed. A power supply line for driving the pixel PX or the like may be disposed in the peripheral area PA. Pads may also be disposed in the peripheral area PA, and a printed circuit board including a drive circuit unit or an integrated circuit device such as a driver integrated circuit (“IC”) may be electrically connected to the above-described pads in the peripheral area PA.

It is noted that the display panel 110 includes a substrate 100, and thus it may be said that the substrate 100 includes the display area DA and the peripheral area PA. Detailed descriptions of the substrate 100 will be provided later.

In some embodiments, a plurality of transistors may be disposed in the display area DA. The plurality of transistors may each have a first electrode and a second electrode, where the first electrode may be a source electrode or a drain electrode depending on the type (N-type or P-type) and/or operating conditions of the transistor, and the second electrode may be an electrode different from the first electrode. In an embodiment, when the first electrode is a source electrode, the second electrode may be a drain electrode, for example.

In an embodiment, the plurality of transistors may include a driving transistor, a data write transistor, a compensation transistor, an initialization transistor, a light-emission control transistor, or the like, for example. The driving transistor may be connected between the drive voltage line PL and an organic light-emitting element (organic light-emitting diode (“OLED”)). The data write transistor may be connected between the data line DL and the driving transistor, and may perform a switching operation for transmitting a data signal transmitted through the data line DL.

The compensation transistor may be turned on in response to a scan signal transmitted through the scan line SL, thereby connecting the driving transistor to the OLED to compensate for a threshold voltage of the driving transistor.

The initialization transistor may be turned on in response to the scan signal transmitted through the scan line SL, and may transmit an initialization voltage to a gate electrode of the driving transistor to initialize the gate electrode of the driving transistor. A scan line connected to the initialization transistor may be a separate scan line different from the scan line connected to the compensation transistor.

The light-emission control transistor may be turned on in response to a light-emission control signal transmitted through a light-emission control line, and as a result, a driving current may flow through the OLED.

The organic light-emitting element may include a pixel electrode (anode) and a counter electrode (cathode), and may receive desired voltages through the pixel electrode and the counter electrode. The organic light-emitting element may emit light by receiving a driving current from the driving transistor, thereby displaying an image.

Hereinafter, an organic light-emitting display device will be described in an embodiment of the display device according to the disclosure, but the display device of the disclosure is not limited thereto. In another embodiment, the display device of the disclosure may be an inorganic light-emitting display (or an inorganic electroluminescent (“EL”) display) device, or a quantum dot light-emitting display device. In an embodiment, a light-emitting layer of the display element included in the display device may include an organic material or an inorganic material, for example. In addition, the display device may include quantum dots disposed on a path of light emitted from the light-emitting layer.

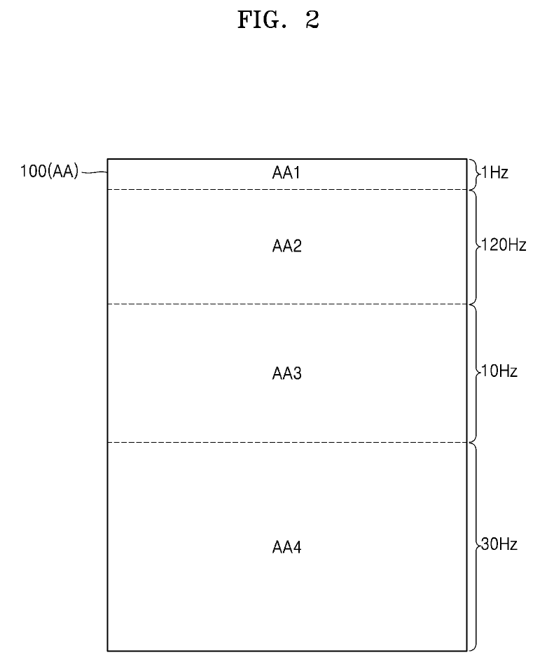

FIG. 2 is a block diagram illustrating an embodiment in which a display panel of a display device is driven according to the disclosure.

As shown in FIG. 2, it is assumed that a first display area AA1 is driven at a driving frequency of 1 hertz (Hz), a second display area AA2 is driven at a driving frequency of 120 Hz, a third display area AA3 is driven at a driving frequency of 10 Hz, and a fourth display area AA4 is driven at a driving frequency of 30 Hz.

In an embodiment, a signal for controlling a scan circuit that outputs gate signals (e.g., an initialization gate signal GI and a compensation gate signal GC) to the first display area AA1 may have an active level at a frequency of 1 Hz, for example. A signal for controlling a scan circuit that outputs gate signals (e.g., the initialization gate signal GI and the compensation gate signal GC) to the second display area AA2 may have an active level at a frequency of 120 Hz. A signal for controlling a scan circuit that outputs gate signals (e.g., the initialization gate signal GI and the compensation gate signal GC) to the third display area AA3 may have an active level at a frequency of 10 Hz. A signal for controlling a scan circuit that outputs gate signals (e.g., the initialization gate signal GI and the compensation gate signal GC) to the fourth display area AA4 may have an active level at a frequency of 30 Hz. In an embodiment the first to fourth display areas AA1 to AA4 may be collectively referred to as a display area AA.

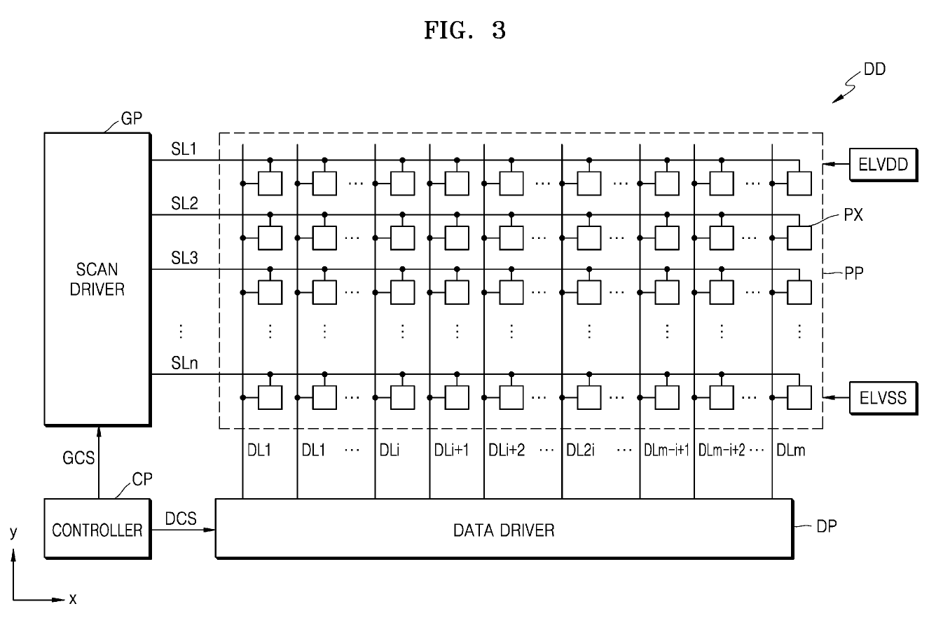

FIG. 3 is a conceptual diagram schematically illustrating an embodiment of the display device according to the disclosure.

As illustrated in FIG. 3, the display device DD may include a pixel portion PP, a scan driver GP, a data driver DP, and a controller CP.

A display area DA may include the pixel portion PP in which a plurality of pixels PX are disposed. A peripheral area PA may include the scan driver GP, the data driver DP, and the controller CP.

Each of the plurality of pixels PX may be connected to a corresponding one of a plurality of scan lines SL1 to SLn (n is a natural number) and a corresponding one of a plurality of data lines DL1 to DLm (m is a natural number). The plurality of scan lines SL1 to SLn may each extend in a first direction (e.g., an x-direction or a row direction) and may be connected to the pixels PX disposed in the same row. Each of the scan lines SL1 to SLn may transmit a scan signal to the pixels PX in the same row. The plurality of data lines DL1 to DLm may each extend in a second direction (e.g., a y-direction or a column direction) and may be connected to the pixels PX disposed in the same column.

The scan driver GP may be connected to the plurality of scan lines SL1 to SLn, may generate scan signals in response to a gate driving control signal GCS from the controller CP, and may sequentially supply the scan signals to the scan lines SL1 to SLn. When the scan signals are sequentially supplied to the scan lines SL1 to SLn, the pixels PX may be selected on a row-by-row basis. Each of the data lines DL1 to DLm may transmit data signals DATA to the pixels PX in the selected row. Each scan line may be connected to a gate of a transistor included in the pixel PX. The scan signal may be a gate control signal for controlling turn-on and turn-off operations of the transistor connected to the scan line. The scan signal may be a square wave signal in which an on-voltage capable of turning on the transistor and an off-voltage capable of turning off the transistor are repeated.

The scan driver GP may be disposed (e.g., mounted) on a display panel 110 as a driving chip. In addition, the scan driver GP may be integrated into the display panel 110. In an embodiment, the scan driver GP may include an amorphous silicon TFT gate driver circuit (“ASG”), a low-temperature polycrystalline silicon TFT gate driver circuit (“LTPS” TFT gate driver circuit), or an oxide semiconductor TFT gate driver circuit (“OSG”), which is embedded in the display panel 110, for example.

The data driver DP may convert an image signal into a data signal in the form of a voltage or current according to a data driving control signal DCS input from the controller CP.

The controller CP may generate the data driving control signal DCS and the gate driving control signal GCS in response to synchronization signals or clock signals supplied from the outside. In an embodiment, the controller CP may be a controller or a component including a controller, for example. The controller CP may output the data driving control signal DCS to the data driver DP and may output the gate driving control signal GCS to the scan driver GP.

The scan driver GP may be directly formed on a substrate 100. The data driver DP may be disposed on a flexible printed circuit board (“FPCB”) that is electrically connected to a pad disposed at one side of the substrate 100. In another embodiment, the data driver DP may be directly disposed on the substrate 100 by a chip-on-glass (“COG”) method or a chip-on-plastic (“COP”) method.

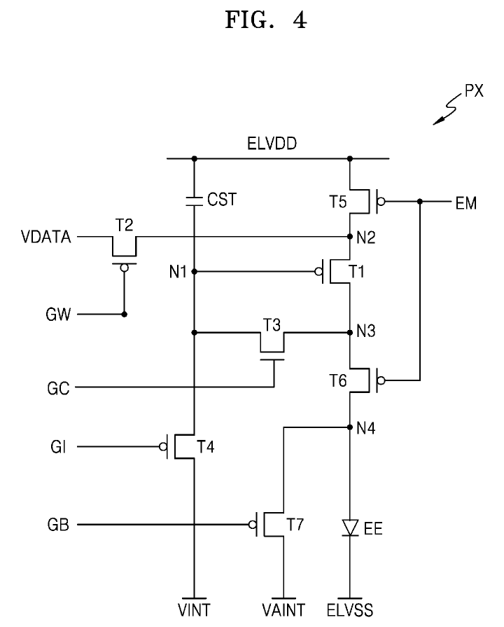

FIG. 4 is a circuit diagram illustrating an embodiment of a pixel circuit according to the disclosure.

Referring to FIG. 4, each of pixels PX may include: a first transistor T1 (i.e., a driving transistor T1) including a control electrode connected to a first node N1, a first electrode connected to a second node N2, and a second electrode connected to a third node N3; a second transistor T2 including a control electrode configured to receive a write gate signal GW, a first electrode configured to receive a data voltage VDATA, and a second electrode connected to the second node N2; a third transistor T3 including a control electrode configured to receive a compensation gate signal GC, a first electrode connected to the third node N3, and a second electrode connected to the first node N1; a fourth transistor T4 including a control electrode configured to receive an initialization gate signal GI, a first electrode configured to receive a first initialization voltage VINT, and a second electrode connected to the first node N1; a fifth transistor T5 including a control electrode configured to receive an emission signal EM, a first electrode configured to receive a first power supply voltage ELVDD (e.g., a relatively high power voltage), and a second electrode connected to the second node N2; a sixth transistor T6 including a control electrode configured to receive the emission signal EM, a first electrode connected to the third node N3, and a second electrode connected to a fourth node N4; a seventh transistor T7 including a control electrode configured to receive a bias gate signal GB, a first electrode configured to receive a second initialization voltage VAINT, and a second electrode connected to the fourth node N4; a storage capacitor CST including a first electrode configured to receive the first power supply voltage ELVDD and a second electrode connected to the first node N1; and a light-emitting element EE including a first electrode (i.e., an anode) connected to the fourth node N4, and a second electrode configured to receive a second power supply voltage ELVSS (e.g., a relatively low power voltage). However, the disclosure is not limited thereto. In an embodiment, each of the pixels PX may have various structures such as a 3T1C structure including three transistors and one capacitor, a 5T2C structure including five transistors and two capacitors, a 7T1C structure including seven transistors and one capacitor, or a 9T1C structure including nine transistors and one capacitor, for example.

The first, second, and fifth to seventh transistors T1, T2, T5, T6, and T7 may be implemented as p-channel metal-oxide-semiconductor (“PMOS”) transistors. In this case, a relatively low voltage level may serve as an active level, and a relatively high voltage level may serve as an inactive level. In an embodiment, when a signal applied to a control electrode of the PMOS transistor has the relatively low voltage level, the PMOS transistor may be turned on, for example. In an embodiment, when a signal applied to the control electrode of the PMOS transistor has the relatively high voltage level, the PMOS transistor may be turned off, for example.

The third and fourth transistors T3 and T4 may be implemented as n-channel metal-oxide-semiconductor (“NMOS”) transistors. In this case, the relatively low voltage level may serve as an inactive level, and the relatively high voltage level may serve as an active level. In an embodiment, when a signal applied to a control electrode of the NMOS transistor has the relatively low voltage level, the NMOS transistor may be turned off, for example. In an embodiment, when a signal applied to the control electrode of the NMOS transistor has the relatively high voltage level, the NMOS transistor may be turned on, for example. That is, the active level and the inactive level may be determined according to the type of the transistor.

However, the disclosure is not limited thereto. In an embodiment, the first, second, and fifth to seventh transistors T1, T2, T5, T6, and T7 may be implemented as NMOS transistors, for example. In an embodiment, the third and fourth transistors T3 and T4 may be implemented as PMOS transistors, for example.

In an embodiment, during an initialization period, the initialization gate signal GI may have an active level, and the fourth transistor T4 may be turned on, for example. Accordingly, the first initialization voltage VINT may be applied to the first node N1 (i.e., a gate initialization operation). That is, the control electrode of the driving transistor T1 (i.e., the storage capacitor CST) may be initialized.

In an embodiment, during a data write period, the write gate signal GW and the compensation gate signal GC may have an active level, and the second transistor T2 and the third transistor T3 may be turned on, for example. Accordingly, the data voltage VDATA may be written to the storage capacitor CST (i.e., a data writing operation).

In an embodiment, during an anode initialization period, the bias gate signal GB may have an active level, and the seventh transistor T7 may be turned on, for example. Accordingly, the second initialization voltage VAINT may be applied to the first electrode (i.e., the anode) of the light-emitting element EE (i.e., an anode initialization operation).

In an embodiment, during a light emission period, the emission signal EM may have an active level, and the fifth transistor T5 and the sixth transistor T6 may be turned on, for example. Accordingly, the first power supply voltage ELVDD may be applied to the driving transistor T1 to generate a driving current, and the driving current may be applied to the light-emitting element EE (i.e., a light emission operation). That is, the light-emitting element EE may emit light with a luminance corresponding to the driving current.

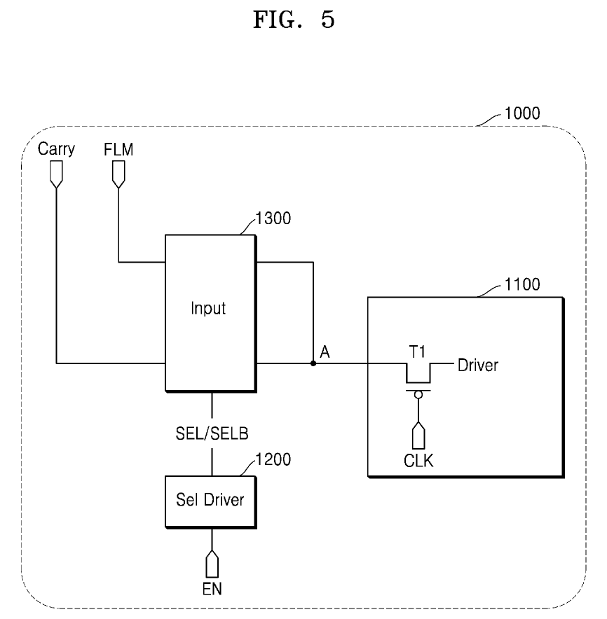

FIG. 5 is a block diagram illustrating an embodiment of a scan driver according to the disclosure.

Referring to FIG. 5, a scan driver 1000 in an embodiment may include a stage 1100, a first circuit 1200, and a second circuit 1300.

In an embodiment, a second circuit 1300 may select either a Carry or a FLM based on the first signal SEL and the second signal SELB, and may provide the selected signal to a stage 1100. Then, the stage 1100 may generate an output signal and provide the output signal to a next stage, which can be provided as a carry signal.

In an embodiment, the first circuit 1200 may receive an enable signal EN. Based on the enable signal EN, the first circuit 1200 may generate a first signal SEL and a second signal SELB for selecting an input signal.

In an embodiment, based on the enable signal EN, a timing at which the first signal SEL and the second signal SELB transition from a relatively high voltage level to a relatively low voltage level, or from the relatively low voltage level to the relatively high voltage level, may be controlled, for example.

In some embodiments, as will be described later, since an input signal transmitted to the stage 1100 is selected based on the first signal SEL and the second signal SELB, the first circuit 1200 may be also referred to as a selection driver in the sense that the first circuit 1200 controls the selection of the input signal.

In an embodiment, the second circuit 1300 may receive the first signal SEL and the second signal SELB, and may transmit one of a first input signal and a second input signal to the stage 1100 based on the first signal SEL and the second signal SELB. In an embodiment, the second circuit 1300 may transmit one of the first input signal and the second input signal to the stage 1100 based on whether the first signal SEL and/or the second signal SELB is at the relatively high voltage level or the relatively low voltage level, for example.

In an embodiment, the stage 1100 may include a driver configured to output a gate signal based on one of the first input signal and the second input signal. In an embodiment, the stage 1100 may include a driver configured to output a gate signal based on one of the first input signal and the second input signal transmitted from the second circuit 1300, for example.

Here, the first input signal and the second input signal may be signals controlled at different driving frequencies. In an embodiment, the first input signal output to a first display area in which a moving image is displayed may have an active level at a frequency of 120 Hz, and the second input signal output to a second display area in which a still image is displayed may have an active level at a frequency of 30 Hz, for example.

This may be because the driver included in the stage in an embodiment outputs a gate signal having a predetermined frequency in response to reception of the first input signal, and outputs a gate signal having a changed frequency relative to the predetermined frequency in response to reception of the second input signal.

In an embodiment, the driver may output a gate signal at 120 Hz in response to reception of the first input signal, and may output a gate signal at 30 Hz in response to reception of the second input signal, for example. Accordingly, the first display area may be driven at 120 Hz, and the second display area may be driven at 30 Hz.

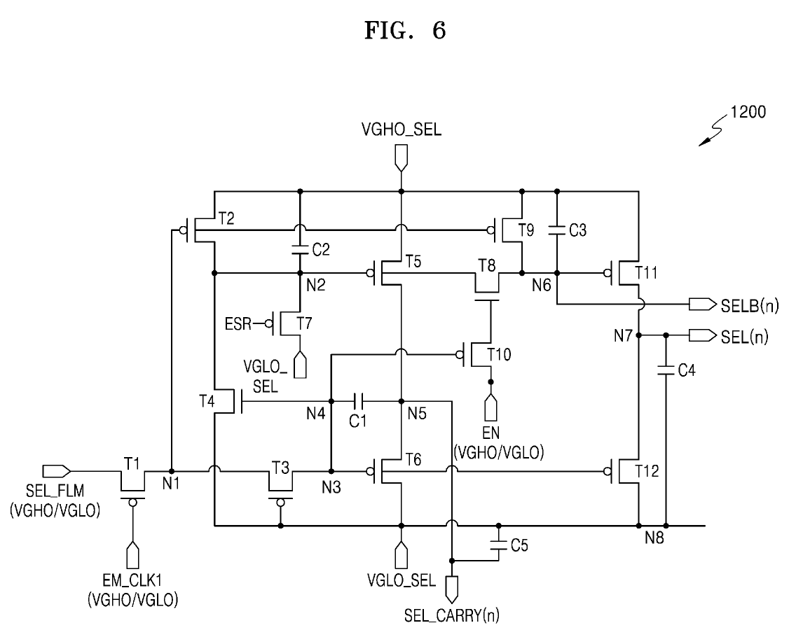

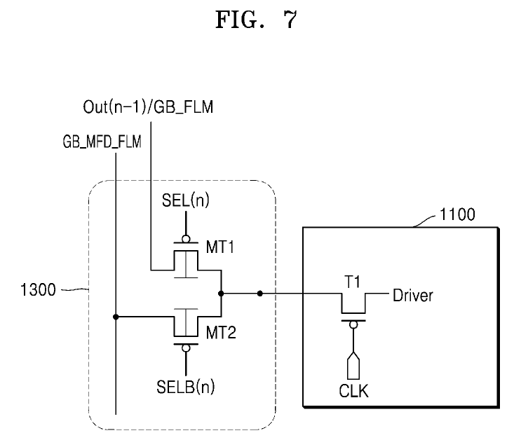

FIG. 6 is a circuit diagram illustrating an embodiment of the first circuit of the scan driver shown in FIG. 5, and FIG. 7 is a circuit diagram illustrating an embodiment of the second circuit of the scan driver shown in FIG. 5.

Referring to FIG. 6, the first circuit 1200 in an embodiment may include a first transistor T1, a second transistor T2, a third transistor T3, a fourth transistor T4, a fifth transistor T5, a sixth transistor T6, a seventh transistor T7, an eighth transistor T8, a ninth transistor T9, a tenth transistor T10, an eleventh transistor T11, and a twelfth transistor T12.

In some embodiments, the first circuit 1200 in an embodiment may include a first capacitor C1, a second capacitor C2, a third capacitor C3, a fourth capacitor C4, and a fifth capacitor C5.

The first transistor T1 may include a first electrode configured to receive a first clock signal SEL_FLM, a gate electrode configured to receive a second clock signal EM_CLK1, and a second electrode connected to a first node N1. In an embodiment, the first transistor T1 may be used to implement sampling of an input signal, for example.

The second transistor T2 may include a gate electrode connected to the first node N1, a first electrode configured to receive a first power supply voltage VGHO_SEL (also referred to as VGHO for convenience), and a second electrode connected to a second node N2. In an embodiment, the second transistor T2 may be used to generate a signal at the second node N2, for example.

The third transistor T3 may include a gate electrode configured to receive a second power supply voltage VGLO_SEL (also referred to as VGLO for convenience), a first electrode connected to the first node N1, and a second electrode connected to a third node N3. In an embodiment, the third transistor T3 may remain in an on-state while the first circuit 1200 is operating, for example.

A fourth transistor T4 may include a gate electrode connected to a fourth node N4, a first electrode connected to the second node N2, and a second electrode configured to receive the second power supply voltage VGLO_SEL. In an embodiment, the fourth transistor T4 may be used to generate a signal at the second node N2, for example.

The fifth transistor T5 may include a gate electrode connected to the second node N2, a first electrode configured to receive the first power supply voltage VGHO_SEL, and a second electrode connected to a fifth node N5. In an embodiment, the fifth transistor T5 may be used as a buffer transistor to ensure a rising time of an output signal, for example.

The sixth transistor T6 may include a gate electrode connected to the third node N3, a first electrode connected to the fifth node N5, and a second electrode configured to receive the second power supply voltage VGLO_SEL. In an embodiment, the sixth transistor T6 may be used as a buffer transistor to ensure a falling time of the output signal, for example.

The seventh transistor T7 may include a gate electrode configured to receive a third power supply voltage ESR, a first electrode connected to the second node N2, and a second electrode configured to receive the second power supply voltage VGLO_SEL. In an embodiment, the seventh transistor T7 may be used to stabilize the first circuit 1200 when initialization of the first circuit 1200 is desired, for example.

The eighth transistor T8 may include a gate electrode connected to a first electrode of the tenth transistor T10, a first electrode connected to the fifth transistor T5, and a second electrode connected to a sixth node N6. In an embodiment, the eighth transistor T8 may determine the first signal SEL based on the enable signal EN, for example.

The ninth transistor T9 may include a gate electrode connected to the second transistor T2, a first electrode configured to receive the first power supply voltage VGHO_SEL, and a second electrode connected to the sixth node N6.

The tenth transistor T10 may include a gate electrode connected to the fourth node N4, the first electrode connected to the gate electrode of the eighth transistor T8, and a second electrode configured to receive the enable signal EN. In an embodiment, the tenth transistor T10 may determine the enable signal EN based on a signal at the third node N3, for example.

The eleventh transistor T11 may include a gate electrode connected to the sixth node N6, a first electrode configured to receive the first power supply voltage VGHO_SEL, and a second electrode connected to a seventh node N7. In an embodiment, the eleventh transistor T11 may be used as a buffer transistor to ensure the rising time of the output signal, for example.

The twelfth transistor T12 may include a gate electrode connected to the sixth transistor T6, a first electrode connected to the seventh node N7, and a second electrode connected to an eighth node N8. In an embodiment, the twelfth transistor T12 may be used as a buffer transistor to ensure the falling time of the output signal, for example.

The first capacitor C1 may include a first electrode connected to the fourth node N4 and a second electrode connected to the fifth node N5.

The second capacitor C2 may include a first electrode configured to receive the first power supply voltage VGHO_SEL and a second electrode connected to the second node N2.

The third capacitor C3 may include a first electrode configured to receive the first power supply voltage VGHO_SEL and a second electrode connected to the sixth node N6.

The fourth capacitor C4 may include a first electrode connected to the seventh node N7 and a second electrode connected to the eighth node N8.

The fifth capacitor C5 may include a first electrode connected to the eighth node N8 and a second electrode configured to receive a carry signal SEL_CARRY.

In an embodiment, the fifth node N5 may represent a node that receives the carry signal SEL_CARRY. In an embodiment, an n-th carry signal SEL_CARRY(n) may refer to the carry signal SEL_CARRY applied to an n-th row.

In an embodiment, the sixth node N6 may represent a node that outputs the second signal SELB. In an embodiment, the second signal SELB of an n-th row may refer to the second signal SELB(n).

In an embodiment, the seventh node N7 may represent a node that outputs the first signal SEL. In an embodiment, the first signal SEL of an n-th row may be referred to as SEL(n).

In another embodiment, the first circuit 1200 may further include a thirteenth transistor and a sixth capacitor.

The thirteenth transistor may include a gate electrode configured to receive the third power supply voltage ESR, a first electrode connected to the first electrode of the sixth capacitor, and a second electrode connected to the second electrode of the sixth capacitor.

The sixth capacitor may include a first electrode connected to the first electrode of the tenth transistor T10, and a second electrode connected to the second electrode of the thirteenth transistor.

Referring to FIG. 7, the second circuit 1300 is illustrated as being connected to the stage 1100 including a bias driver.

In an embodiment, the second circuit 1300 may include a first transistor MT1 including a gate electrode configured to receive the first signal SEL, a first electrode configured to receive a first input signal GB_FLM, and a second electrode connected to an input node of the stage 1100, and a second transistor MT2 including a gate electrode configured to receive the second signal SELB, a first electrode configured to receive a second input signal GB_MFD_FLM, and a second electrode connected to the input node of the stage 1100, for example. In an embodiment, the second circuit 1300 may include a first transistor MT1 including a first electrode configured to receive an output signal Out(n-1) from a previous stage ((n-1)-th stage).

In an embodiment, the first transistor MT1 and the second transistor MT2 may each be implemented as one of a PMOS transistor and an NMOS transistor. In an embodiment, both the first transistor MT1 and the second transistor MT2 may be implemented as PMOS transistors, or NMOS transistors.

Referring to FIG. 7, it is illustrated that the first transistor T1 and the second transistor T2 are both implemented as PMOS transistors.

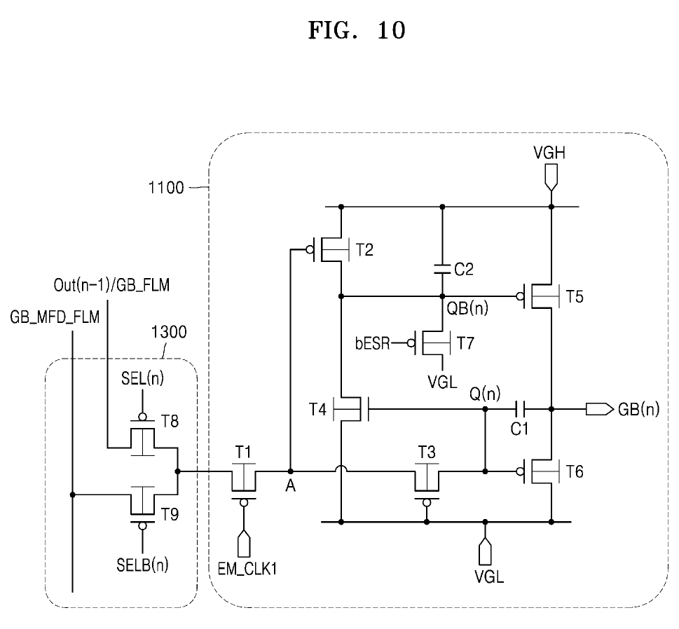

In another embodiment, the first transistor T1 may be implemented as one of a PMOS transistor and an NMOS transistor, and the second transistor T2 may be implemented as a remaining (the other) one of the PMOS transistor and the NMOS transistor. In an embodiment, a gate electrode of the first transistor T1 may receive a clock signal CLK (e.g., a second clock signal EM_CLK1 in FIG. 10).

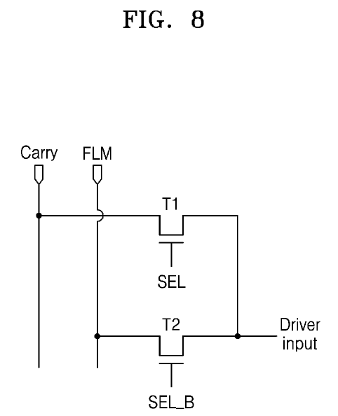

FIG. 8 is a circuit diagram illustrating another embodiment of the second circuit of the scan driver shown in FIG. 5.

The first transistor T1 and the second transistor T2, in the embodiment described above with reference to FIG. 7, may both be implemented as NMOS transistors. Referring to FIG. 8, it is illustrated that the first transistor T1 and the second transistor T2 are both implemented as NMOS transistors.

A detailed description of the first transistor T1 and the second transistor T2 included in the second circuit 1300 has already been provided with reference to FIG. 7, for example, and will thus be omitted herein.

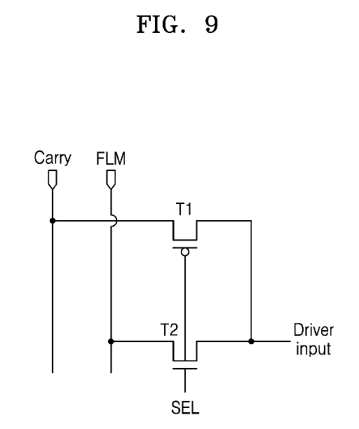

FIG. 9 is a circuit diagram illustrating another embodiment of the second circuit of the scan driver shown in FIG. 5.

The first transistor T1 in the embodiment described above with reference to FIG. 7 may be implemented as one of a PMOS transistor and an NMOS transistor, and the second transistor T2 may be implemented as a remaining (the other) one of the PMOS transistor and an n-channel metal-oxide-semiconductor (“NMOS”) transistor.

Referring to FIG. 9, it is illustrated that the first transistor T1 is implemented as a PMOS transistor and the second transistor T2 is implemented as an NMOS transistor. In another embodiment, the first transistor T1 may be implemented as an NMOS transistor and the second transistor T2 may be implemented as a PMOS transistor (not shown).

In an embodiment, a detailed description of the first transistor T1 and the second transistor T2 included in the second circuit 1300 has already been provided with reference to FIG. 7 and will thus be omitted herein for example.

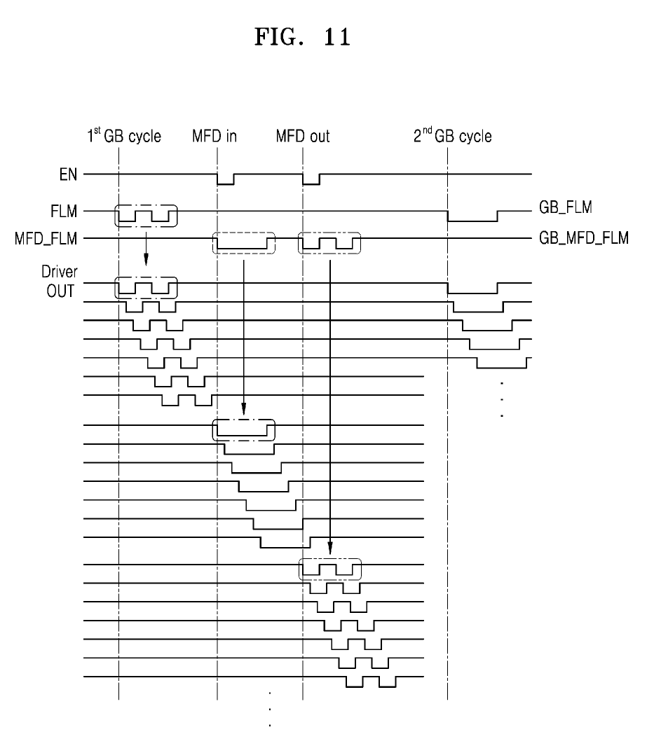

FIG. 10 is a circuit diagram illustrating an embodiment of the scan driver shown in FIGS. 5, and 11 is a timing diagram illustrating an embodiment of an operation of the scan driver shown in FIG. 5.

Referring to FIG. 10, the second circuit 1300 that receives the first signal SEL and the second signal SELB from the first circuit (not shown), and the stage 1100 that receives an input signal selected by the second circuit 1300 are illustrated.

In an embodiment, as illustrated in FIG. 10, a first transistor T8 and a second transistor T9 included in the second circuit 1300 may both be implemented as PMOS transistors, for example.

In an embodiment, when the first signal SEL is at the relatively low voltage level and the second signal SELB is at the relatively high voltage level, the second circuit 1300 may select the first input signal GB_FLM, for example. In another embodiment, when the first signal SEL is at the relatively high voltage level and the second signal SELB is at the relatively low voltage level, the second circuit 1300 may select the second input signal GB_MFD_FLM.

Referring to FIG. 10, the second circuit 1300 is illustrated as being connected to the stage 1100 including a bias driver. In another embodiment, the second circuit 1300 may be connected to the stage 1100 including an initialization driver, a compensation driver, a write driver, or the like.

In an embodiment, the types of drivers that may be connected to the second circuit 1300 are not limited to those described above, for example.

The scan driver according to the disclosure may control an output timing of a driver to match a desired timing based on one of the first input signal and the second input signal. In an embodiment, a relatively high voltage VGH and a relatively low voltage VGL may be applied to the stage 1100, and the stage 1100 may include a node Q(n) and a node QB(n). The stage 1100 may output an n-th bias gate signal GB(n).

Referring to FIG. 11, it is illustrated that the scan driver according to the disclosure controls an output timing of the bias driver to match a desired timing based on the first input signal or the second input signal. In an embodiment, the scan driver according to the disclosure may control the output timing of the driver to match a desired timing based on the first input signal or the second input signal determined based on the first signal and the second signal, for example.

In an embodiment, the stage may include a driver configured to output a gate signal based on one of the first input signal and the second input signal. The stage in an embodiment may include a driver configured to output a gate signal at a predetermined frequency in response to reception of the first input signal, and to output a gate signal at a changed frequency relative to the predetermined frequency in response to reception of the second input signal.

Referring to FIG. 11, it is illustrated that the driver in an embodiment outputs a gate signal at a predetermined frequency in response to reception of the first input signal (GB_FLM or also referred to as FLM for convenience).

In this case, the driver according to an embodiment may output the gate signal at a changed frequency relative to the predetermined frequency in response to reception of the second input signal (GB_MFD_FLM or also referred to as MFD_FLM for convenience). In addition, the driver in an embodiment may again output a gate signal having the changed frequency relative to the predetermined frequency in response to reception of the second input signal.

Accordingly, the scan driver according to the disclosure may control the output timing of the driver to match a desired timing, thereby enabling each display area included in the display panel to be driven at a different frequency.

The display device in the embodiment of the disclosure may be applied to various electronic devices. The electronic device in an embodiment may include the display device described above and may further include modules or devices having additional functions other than the display device.

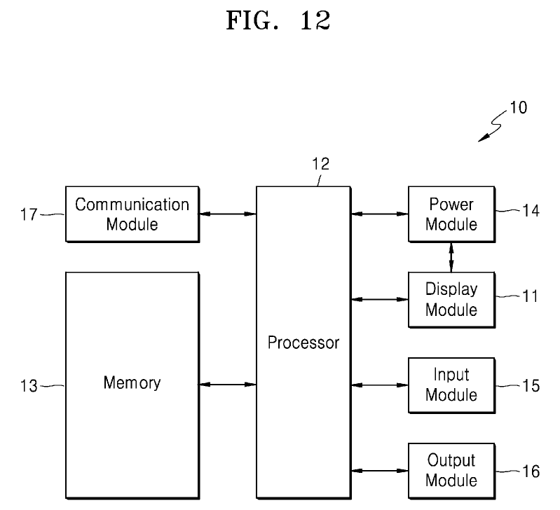

FIG. 12 is a block diagram of an embodiment of an electronic device according to the disclosure. Referring to FIG. 12, an electronic device 10 in an embodiment may include a display module 11, a processor 12, a memory 13, and a power module 14.

The processor 12 may include at least one of a central processing unit (“CPU”), an application processor (“AP”), a graphic processing unit (“GPU”), a communication processor (“CP”), an image signal processor (“ISP”), and a controller.

In an embodiment, the processor 12 may be provided in a form divided into two or more parts from a functional or structural perspective. In an embodiment, the processor 12 may include a main processor in the form of a first driving chip including a central processing unit, and a sub-processor in the form of a second driving chip including a controller configured to receive a video signal from the main processor and process the video signal to comply with interface specifications of the display module 11, for example.

The electronic device 10 in an embodiment may include a controller and a driving circuit. In this case, the controller in an embodiment may be the controller included in the sub-processor in the form of the second driving chip described above.

The controller in an embodiment may receive a multi-frequency driving flag signal from the processor 12. At this time, the processor 12 in an embodiment may be the main processor in the form of the first driving chip described above. The controller in an embodiment may output a multi-frequency driving control signal and generate a scan input signal in response to reception of the multi-frequency driving flag signal. In this case, the generated scan input signal may be applied to the display module 11.

The driving circuit in an embodiment may receive the multi-frequency driving control signal and may include a scan driver configured to output a signal for driving each display area included in a display panel at a different frequency. In an embodiment, the scan driver included in the driving circuit in an embodiment may correspond to the scan driver according to the disclosure described above with reference to FIGS. 2 to 11, for example.

The memory 13 may include at least one of a non-volatile memory and a volatile memory. Data and information desired for the operation of the processor 12 or the display module 11 may be stored in the memory 13. When the processor 12 executes an application stored in the memory 13, an image data signal (e.g., video data signal) and/or an input control signal may be transmitted to the display module 11, and the display module 11 may process the received signal and output image information (e.g., video information) through a display screen.

The power module 14 may include a power supply module, such as a power adapter or a battery device, and a power conversion module configured to convert the power supplied by the power supply module into power desired for the operation of the electronic device 10. The power conversion by the power conversion module may include direct current-to-direct current (“DC-DC”) conversion, alternating current-to-direct current (“AC-DC”) conversion, or direct current-to-alternating current (“DC-AC”) conversion, but the disclosure is not limited thereto.

At least one of the components of the electronic device 10 described above may be included in the display device in the embodiments described above. In addition, a portion of individual modules included functionally in one module may be included in the display device, while another portion thereof may be provided separately from the display device. In an embodiment, the display device may include the display module 11, and the processor 12, the memory 13, and the power module 14 may be provided as a separate device within the electronic device 10, rather than within the display device, for example.

In another embodiment, the power module 14 may be provided within the display device and may supply power to the processor 12 and the memory 13 provided within the electronic device 10, rather than within the display device, without being limited to the above examples.

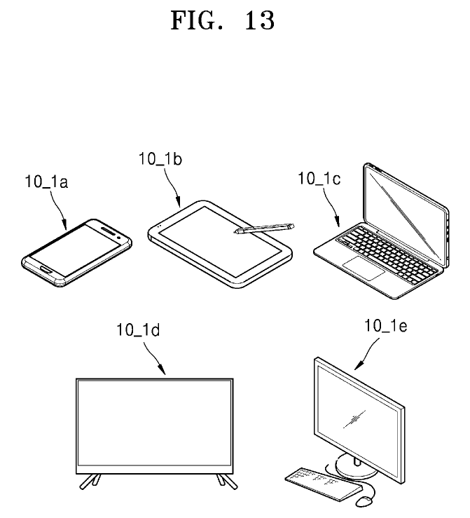

FIG. 13 is a set of schematic views of embodiments of electronic devices.

Referring to FIG. 13, various electronic devices to which the display device in the embodiments are applied may include not only image display electronic devices such as a smartphone 10_1a, a tablet personal computer (“PC”) 10_1b, a laptop computer 10_1c, a television (“TV”) 10_1d, and a desktop monitor 10_1e, but also wearable electronic devices including a display module, such as smart glasses, a head-mounted display, and a smart watch, and vehicle electronic devices including a display module, such as an instrument cluster, a center fascia, a center information display (“CID”) disposed on a dashboard, and a room mirror display.

The electronic devices illustrated in FIG. 13 may include the components illustrated in FIG. 12. In an embodiment, the smartphone 10_1a may include the display module 11, the processor 12, the memory 13, and the power module 14 illustrated in FIG. 12. The smartphone 10_1a may further include a communication module and a battery device, for example. Power supplied from the battery device may be converted by the power module 14 and provided to the processor 12, the memory 13, and the display module 11. In an embodiment, the display device applied to the smartphone 10_1a may include the display module 11 and may further include the power module 14. The processor 12 and the memory 13 may be provided in the form of chips disposed (e.g., mounted) on a motherboard, which is an external device, but the disclosure is not limited thereto.

Each of the embodiments described above may be implemented independently, but the structures of the embodiments may also be combined and applied to other embodiments.

In an embodiment of the disclosure, a first display area displaying a moving image and a second display area displaying a still image may be driven at different frequencies.

In an embodiment of the disclosure, timings of gate signals for the first display area and the second display area described above may be individually controlled, thereby enabling variable refresh rate (“VRR”) characteristics and flicker characteristics.

The effects of the disclosure are not limited to the effects described above, and may be expanded in various ways without departing from the spirit and scope of the disclosure.

The disclosure has been described with reference to the embodiments illustrated in the drawings, but these are only examples. It will be understood by those skilled in the art that various modifications and equivalent other embodiments may be made. Accordingly, the true technical scope of the disclosure is defined by the technical spirit of the appended claims.

The particular implementations shown and described herein are illustrative embodiments of the embodiments and are not intended to otherwise limit the scope of the embodiments in any way. In addition, no item or element is essential to the practice of the disclosure unless the element is specifically described as “essential” or “critical.”

The use of the terms “a” and “an” and “the” and similar referents in the context of describing the disclosure (especially in the context of the following claims) are to be construed to cover both the singular and the plural. Further, recitation of ranges of values herein are merely intended to serve as a shorthand method of referring individually to each separate value falling within the range, unless otherwise indicated herein, and each separate value is incorporated into the specification as when it were individually recited herein. Finally, operations of all methods described herein may be performed in any suitable order unless otherwise indicated herein or otherwise clearly contradicted by context. The disclosure is not necessarily limited to the described order of the operations. The use of any and all examples, or exemplary terms provided herein, is intended merely to better illustrate the embodiments and does not pose a limitation on the scope of the embodiments unless otherwise claimed. Also, numerous modifications and adaptations will be readily apparent to one of ordinary skill in the art without departing from the spirit and scope of the disclosure.

What is claimed is:

1. A scan driver comprising:
a stage configured to generate a carry signal and provide the carry signal to a next stage, the stage including:
a driver configured to output a gate signal;
a first circuit configured to receive an enable signal and generate, based on the enable signal, a first signal and a second signal which select an input signal; and
a second circuit configured to receive the first signal and the second signal and provide one of a first input signal and a second input signal to the stage based on the first signal and the second signal,
wherein the gate signal is output based on one of the first input signal and the second input signal.

2. The scan driver of claim 1, wherein the second circuit includes:
a first transistor including a gate electrode configured to receive the first signal, a first electrode configured to receive the first input signal, and a second electrode connected to an input node of the stage; and
a second transistor including a gate electrode configured to receive the second signal, a first electrode configured to receive the second input signal, and a second electrode connected to the input node of the stage.

3. The scan driver of claim 2, wherein each of the first transistor and the second transistor is one of a P-channel metal oxide semiconductor transistor and an N-channel metal oxide semiconductor transistor.

4. The scan driver of claim 3, wherein
when the first transistor and the second transistor are identically configured as either the P-channel metal oxide semiconductor transistor or the N-channel metal oxide semiconductor transistor,
one of the first signal and the second signal is a relatively high signal, and
a remaining one of the first signal and the second signal is a relatively low signal.

5. The scan driver of claim 3, wherein, when one of the first transistor and the second transistor is the P-channel metal oxide semiconductor transistor and a remaining one of the first transistor and the second transistor is the N-channel metal oxide semiconductor transistor, both the first signal and the second signal are either relatively high signals or relatively low signals.

6. The scan driver of claim 1, wherein the first circuit includes:
a first transistor including a first electrode configured to receive a first clock signal, a gate electrode configured to receive a second clock signal, and a second electrode connected to a first node;
a second transistor including a gate electrode connected to the first node, a first electrode configured to receive a first power supply voltage, and a second electrode connected to a second node;
a third transistor including a gate electrode configured to receive a second power supply voltage, a first electrode connected to the first node, and a second electrode connected to a third node;
a fourth transistor including a gate electrode connected to a fourth node, a first electrode connected to the second node, and a second electrode configured to receive the second power supply voltage;
a fifth transistor including a gate electrode connected to the second node, a first electrode configured to receive the first power supply voltage, and a second electrode connected to a fifth node;
a sixth transistor including a gate electrode connected to the third node, a first electrode connected to the fifth node, and a second electrode configured to receive the second power supply voltage;
a seventh transistor including a gate electrode configured to receive a third power supply voltage, a first electrode connected to the second node, and a second electrode configured to receive the second power supply voltage;
an eighth transistor including a gate electrode connected to a first electrode of a tenth transistor, a first electrode connected to the fifth transistor, and a second electrode connected to a sixth node;
a ninth transistor including a gate electrode connected to the second transistor, a first electrode configured to receive the first power supply voltage, and a second electrode connected to the sixth node;
the tenth transistor including a gate electrode connected to the fourth node, a first electrode connected to the gate electrode of the eighth transistor, and a second electrode configured to receive the enable signal;
an eleventh transistor including a gate electrode connected to the sixth node, a first electrode configured to receive the first power supply voltage, and a second electrode connected to a seventh node;
a twelfth transistor including a gate electrode connected to the sixth transistor, a first electrode connected to the seventh node, and a second electrode connected to an eighth node;
a first capacitor;
a second capacitor;
a third capacitor;
a fourth capacitor; and
a fifth capacitor,
wherein the first capacitor includes a first electrode connected to the fourth node and a second electrode connected to the fifth node,
the second capacitor includes a first electrode configured to receive the first power supply voltage and a second electrode connected to the second node,
the third capacitor includes a first electrode configured to receive the first power supply voltage and a second electrode connected to the sixth node,
the fourth capacitor includes a first electrode connected to the seventh node and a second electrode connected to the eighth node, and
the fifth capacitor includes a first electrode connected to the eighth node and a second electrode configured to receive the carry signal.

7. The scan driver of claim 1, wherein the driver is configured to output the gate signal at a predetermined frequency in response to reception of the first input signal, and to output the gate signal at a changed frequency relative to the predetermined frequency in response to reception of the second input signal.

8. A display device comprising:
a substrate including:
a display area; and
a peripheral area disposed around the display area;
a pixel circuit disposed in the display area; and
a scan driver disposed in the peripheral area and electrically connected to the pixel circuit, the scan driver including:
a stage configured to generate a carry signal and provide the carry signal to a next stage, the stage including:
a driver configured to output a gate signal;
a first circuit configured to receive an enable signal and generate, based on the enable signal, a first signal and a second signal which select an input signal; and
a second circuit configured to receive the first signal and the second signal and provide one of a first input signal and a second input signal to the stage based on the first signal and the second signal,
wherein the gate signal is output based on one of the first input signal and the second input signal.

9. The display device of claim 8, wherein the second circuit includes:
a first transistor including a gate electrode configured to receive the first signal, a first electrode configured to receive the first input signal, and a second electrode connected to an input node of the stage; and
a second transistor including a gate electrode configured to receive the second signal, a first electrode configured to receive the second input signal, and a second electrode connected to the input node of the stage.

10. The display device of claim 9, wherein each of the first transistor and the second transistor is one of a P-channel metal oxide semiconductor transistor and an N-channel metal oxide semiconductor transistor.

11. The display device of claim 10, wherein
when the first transistor and the second transistor are identically configured as either the P-channel metal oxide semiconductor transistor or the N-channel metal oxide semiconductor transistor,
one of the first signal and the second signal is a relatively high signal, and
a remaining one of the first signal and the second signal is a relatively low signal.

12. The display device of claim 10, wherein, when one of the first transistor and the second transistor is the P-channel metal oxide semiconductor transistor and a remaining one of the first transistor and the second transistor is the N-channel metal oxide semiconductor transistor, both the first signal and the second signal are either relatively high signals or relatively low signals.

13. The display device of claim 8, wherein the first circuit includes:
a first transistor including a first electrode configured to receive a first clock signal, a gate electrode configured to receive a second clock signal, and a second electrode connected to a first node;
a second transistor including a gate electrode connected to the first node, a first electrode configured to receive a first power supply voltage, and a second electrode connected to a second node;
a third transistor including a gate electrode configured to receive a second power supply voltage, a first electrode connected to the first node, and a second electrode connected to a third node;
a fourth transistor including a gate electrode connected to a fourth node, a first electrode connected to the second node, and a second electrode configured to receive the second power supply voltage;
a fifth transistor including a gate electrode connected to the second node, a first electrode configured to receive the first power supply voltage, and a second electrode connected to a fifth node;
a sixth transistor including a gate electrode connected to the third node, a first electrode connected to the fifth node, and a second electrode configured to receive the second power supply voltage;
a seventh transistor including a gate electrode configured to receive a third power supply voltage, a first electrode connected to the second node, and a second electrode configured to receive the second power supply voltage;
an eighth transistor including a gate electrode connected to a first electrode of a tenth transistor, a first electrode connected to the fifth transistor, and a second electrode connected to a sixth node;
a ninth transistor including a gate electrode connected to the second transistor, a first electrode configured to receive the first power supply voltage, and a second electrode connected to the sixth node;
the tenth transistor including a gate electrode connected to the fourth node, the first electrode connected to the gate electrode of the eighth transistor, and a second electrode configured to receive the enable signal;
an eleventh transistor including a gate electrode connected to the sixth node, a first electrode configured to receive the first power supply voltage, and a second electrode connected to a seventh node;
a twelfth transistor including a gate electrode connected to the sixth transistor, a first electrode connected to the seventh node, and a second electrode connected to an eighth node;
a first capacitor;
a second capacitor;
a third capacitor;
a fourth capacitor; and
a fifth capacitor,
wherein the first capacitor includes a first electrode connected to the fourth node and a second electrode connected to the fifth node,
the second capacitor includes a first electrode configured to receive the first power supply voltage and a second electrode connected to the second node,
the third capacitor includes a first electrode configured to receive the first power supply voltage and a second electrode connected to the sixth node,
the fourth capacitor includes a first electrode connected to the seventh node and a second electrode connected to the eighth node, and
the fifth capacitor includes a first electrode connected to the eighth node and a second electrode configured to receive the carry signal.

14. The display device of claim 8, wherein the driver is configured to output the gate signal at a predetermined frequency in response to reception of the first input signal, and to output the gate signal at a changed frequency relative to the predetermined frequency in response to reception of the second input signal.

15. An electronic device comprising:
a memory;
a processor configured to execute an application stored in the memory; and
a display module configured to receive an image data signal from the processor, process the image data signal, and output image information;
a controller configured to receive a multi-frequency driving flag signal from the processor, output a multi-frequency driving control signal based on the multi-frequency driving flag signal, and generate a scan input signal; and
a driving circuit including:
a scan driver configured to receive the multi-frequency driving control signal and output a signal for driving each display area of a display panel at a different frequency, the scan driver including:
a stage configured to generate a carry signal and provide the carry signal to a next stage, the stage including:
a driver configured to output a gate signal;
a first circuit configured to receive an enable signal according to the multi-frequency driving control signal and generate, based on the enable signal, a first signal and a second signal which are for selecting the gate signal; and
a second circuit configured to receive the first signal and the second signal and provide one of a first input signal and a second input signal to the stage based on the first signal and the second signal,
wherein the gate signal is output based on one of the first input signal and the second input signal.

16. The electronic device of claim 15, wherein the second circuit includes:
a first transistor including a gate electrode configured to receive the first signal, a first electrode configured to receive the first input signal, and a second electrode connected to an input node of the stage; and
a second transistor including a gate electrode configured to receive the second signal, a first electrode configured to receive the second input signal, and a second electrode connected to the input node of the stage.

17. The electronic device of claim 16, wherein each of the first transistor and the second transistor is one of a P-channel metal oxide semiconductor transistor and an N-channel metal oxide semiconductor transistor.

18. The electronic device of claim 17, wherein
when the first transistor and the second transistor are identically configured as either the P-channel metal oxide semiconductor transistor or the N-channel metal oxide semiconductor transistor,
one of the first signal and the second signal is a relatively high signal, and
the other is a relatively low signal.

19. The electronic device of claim 17, wherein, when one of the first transistor and the second transistor is the P-channel metal oxide semiconductor transistor and a remaining one of the first transistor and the second transistor is the N-channel metal oxide semiconductor transistor, both the first signal and the second signal are either relatively high signals or relatively low signals.

20. The electronic device of claim 17, wherein the first circuit includes:
a first transistor including a first electrode configured to receive a first clock signal, a gate electrode configured to receive a second clock signal, and a second electrode connected to a first node;
a second transistor including a gate electrode connected to the first node, a first electrode configured to receive a first power supply voltage, and a second electrode connected to a second node;
a third transistor including a gate electrode configured to receive a second power supply voltage, a first electrode connected to the first node, and a second electrode connected to a third node;
a fourth transistor including a gate electrode connected to a fourth node, a first electrode connected to the second node, and a second electrode configured to receive the second power supply voltage;
a fifth transistor including a gate electrode connected to the second node, a first electrode configured to receive the first power supply voltage, and a second electrode connected to a fifth node;
a sixth transistor including a gate electrode connected to the third node, a first electrode connected to the fifth node, and a second electrode configured to receive the second power supply voltage;
a seventh transistor including a gate electrode configured to receive a third power supply voltage, a first electrode connected to the second node, and a second electrode configured to receive the second power supply voltage;
an eighth transistor including a gate electrode connected to a first electrode of a tenth transistor, a first electrode connected to the fifth transistor, and a second electrode connected to a sixth node;
a ninth transistor including a gate electrode connected to the second transistor, a first electrode configured to receive the first power supply voltage, and a second electrode connected to the sixth node;
the tenth transistor including a gate electrode connected to the fourth node, the first electrode connected to the gate electrode of the eighth transistor, and a second electrode configured to receive the enable signal;
an eleventh transistor including a gate electrode connected to the sixth node, a first electrode configured to receive the first power supply voltage, and a second electrode connected to a seventh node;
a twelfth transistor including a gate electrode connected to the sixth transistor, a first electrode connected to the seventh node, and a second electrode connected to an eighth node;
a first capacitor;
a second capacitor;
a third capacitor;
a fourth capacitor; and
a fifth capacitor,
wherein the first capacitor includes a first electrode connected to the fourth node and a second electrode connected to the fifth node,
the second capacitor includes a first electrode configured to receive the first power supply voltage and a second electrode connected to the second node,
the third capacitor includes a first electrode configured to receive the first power supply voltage and a second electrode connected to the sixth node,
the fourth capacitor includes a first electrode connected to the seventh node and a second electrode connected to the eighth node, and
the fifth capacitor includes a first electrode connected to the eighth node and a second electrode configured to receive the carry signal.
